(19) United States
(12) Patent Application Publication
(10) Pub. No.: US 2003/0098629 A1
(43) Pub. Date: May 29, 2003

(54) Stator for a motor

(75) Inventors: Ching-Feng Lai, Taichung (TW); Chun-Chung Yang, Hsinchu (TW); Yu-Chuong Chang, Hsinchu Hsien (TW)

Correspondence Address: INTELLECTUAL PROPERTY SOLUTIONS, INCORPORATED, 5717 COLFAX AVENUE, ALEXANDRIA, VA, 22311, US

(73) Assignee: INDUSTRIAL TECHNOLOGY RESEARCH INSTITUTE, Hsinchu (TW)

(21) Appl. No.: 10/087,734

(22) Filed: Mar. 5, 2002

(30) Foreign Application Priority Data
Nov. 29, 2001 (TW) 90220673

(51) Int. Cl. H02K 1/00; H02K 1/12

(52) U.S. Cl. 310/254; 310/216; 310/42

(57) ABSTRACT

A stator for a motor. The stator includes a core, a plurality of insulators, a plurality of windings, and a plurality of back-iron portions. The core is provided with a hollow portion and a plurality of tooth portions protruding from the hollow portion in a radial manner. The insulators, corresponding to the tooth portions, are disposed around the corresponding tooth portion respectively. The windings, corresponding to the insulators, are disposed around the corresponding insulator respectively. The back-iron portions surround the core and contact the insulators along a direction opposite to the protruding direction of the tooth portions.

### BACKGROUND OF THE INVENTION

1. Field of the Invention

The invention relates to a stator for a motor; in particular, the invention relates to a stator that can protect its insulators from damage.

2. Description of the Related Art

Brushless motors, due to properties such as potential for miniaturization, relative flatness and good concealment, are commonly used in small machines as well as some precision automatic controlling systems. At present, brushless motor with permanent magnets can be classified into three main types, namely: diametrically wound with diametrical air-gap, axially wound with axial air-gap and axially wound with diametrical air-gap. Amongst the three, axially wound with diametrical air-gap types of brushless motors have relatively lower production cost and higher yield, and find application in environments requiring moderately low output torque.

Referring to FIG. 1, a stator 10 of a conventional brushless motor that is an axially wound with diametrical air-gap type comprises a core with plural teeth 11, and a plurality of winding portions 13. A gap 12 is formed between adjacent teeth 11 so as to pass through the winding portions 13. However, when a rotor of the motor rotates, there will be a corresponding increase in the cogging torque of the motor. Consequently, whenever the power output of the motor is increased, vibrations and noise will occur, compromising the controllability and life of the motor. As well, the conventional gap design of the stator profile has rather small shield effectiveness leading to larger flux leakage and lower inductive torque. Furthermore, since the winding portions 12 must pass through the gaps 13, it is difficult to wind around the teeth 11. Thus, the number of winding portions 12 around the teeth 11 cannot be optimized.

In view of the above problem, another conventional stator 20 is provided, as shown in FIG. 2. The stator 20 comprises a core 21 with plural teeth 211, a back-iron portion 22, and a plurality of winding portions 23. Referring to FIG. 3, each of the winding portions 23 is provided with an insulator 232 and a winding 231 wound around the insulator 232. The winding portions 23 are disposed around the teeth 211 of the core 21 along a radial direction of the teeth 211 of the core 21 (arrow X in FIG. 2). The back-iron portion 22 is disposed around the teeth 211 of the core 21 along an axial direction of the core 21 (perpendicular to the paper of FIG. 2).

Since there is no gap formed in the stator 20, the problem of cogging torque can be solved. In addition, since the winding portions 23 are assembled to the teeth 211 of the core 21 along a radial direction of the teeth 211 of the core 21, it is easy to dispose the winding portions 23 around the teeth 211 of the core 21. Thus, the amount of windings 231 of the winding portions 23 wound around the teeth 211 can be maximized.

However, the stator 20 has the following disadvantages:

1. When the size of the motor increases, the size of the back-iron portion 22 of the stator 20 also increases. Thus, equipment with larger size is required. As well, since the size of the back-iron portion 22 increases, a magnetic material A for manufacturing the back-iron portion 22 requires larger size L. As a result, every time a back-portion 22 is manufactured, a lot of scraps remain.

2. Since the back-iron portion 22 is assembled to the core 21 along an axial direction of the core 21, it is easy to damage the insulators 232 of the winding portions 23. As a result, when the rotor rotates, it is easily burned out, reducing the reliability of the rotor.

### SUMMARY OF THE INVENTION

In order to address the disadvantages of the aforementioned stator for a motor, the invention provides a stator that can protect its insulators from damage.

Another purpose of this invention is to reduce the amount of scrap produced when manufacturing the stator.

Accordingly, the invention provides a stator for a motor. It comprises a core, a plurality of insulators, a plurality of windings, and a plurality of back-iron portions. The core is provided with a hollow portion and a plurality of tooth portions protruding from the hollow portion in a radial manner. The insulators, corresponding to the tooth portions, are disposed around the corresponding tooth portion respectively. The windings, corresponding to the insulators, are disposed around the corresponding insulator respectively. The back-iron portions surround the core and contact the insulators along a direction opposite to the protruding direction of the tooth portions.

In a preferred embodiment, the back-iron portions are connected with each other by welding.

In another preferred embodiment, the back-iron portions are connected with each other by adhesion.

In another preferred embodiment, each of the back-iron portions is provided with a recessed portion and a projecting portion, whereby the back-iron portions are connected with each other by the engagement between the recessed portion and the projecting portion.

In a preferred embodiment, the stator further comprises a restricting portion surrounding the back-iron portions so that the back-iron portions contact each other around the core.

It is understood that the core can be magnetic material and the back-iron portions can be magnetic material.

### BRIEF DESCRIPTION OF THE DRAWINGS

The invention is hereinafter described in detail with reference to the accompanying drawings in which:

FIG. 1 is a schematic view of a conventional stator for a motor;

FIG. 2 is a schematic view of another conventional stator for a motor;

FIG. 3 is a perspective view of a winding portion as shown in FIG. 2;

FIG. 4 is a schematic view that shows a method of manufacturing a back-iron portion as shown in FIG. 2;

FIG. 5 is a schematic view that shows a method of manufacturing a back-iron portion as disclosed in this invention;

FIG. 6 is a schematic view of a stator for a motor as disclosed in a first embodiment of this invention;

FIG. 7 is a schematic view of a stator for a motor as disclosed in a second embodiment of this invention; and

FIG. 8 is a schematic view of a stator for a motor as disclosed in a third embodiment of this invention.

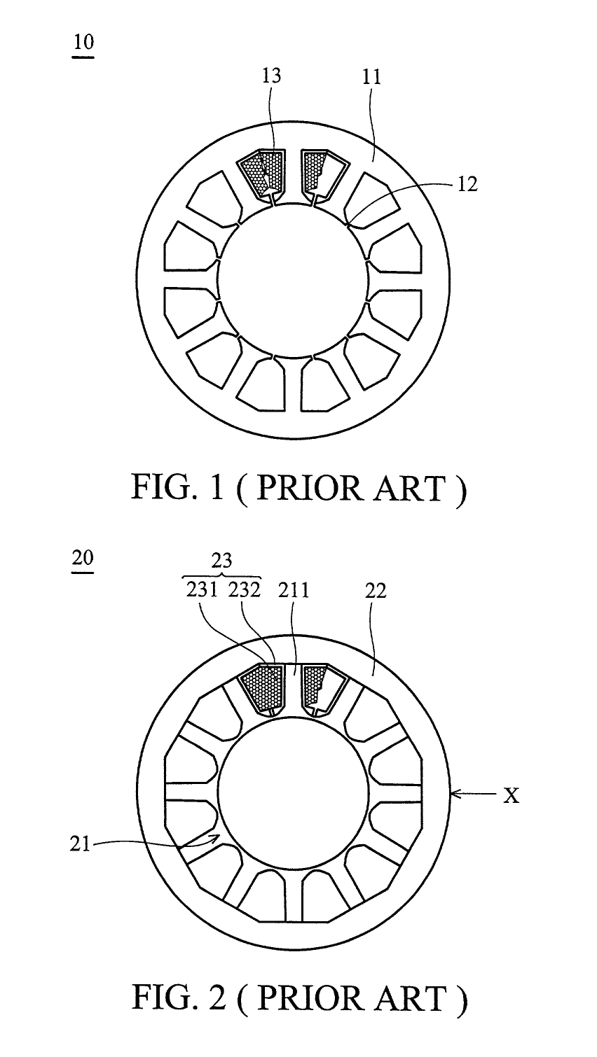

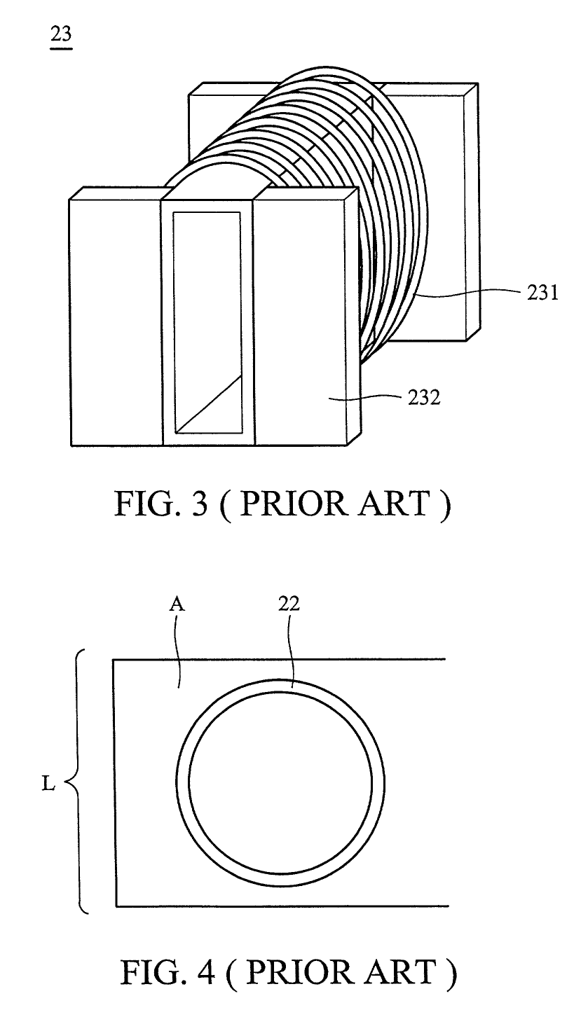

### DETAILED DESCRIPTION OF THE INVENTION

First Embodiment

Referring to FIG. 6, a stator 30 for a motor, as disclosed in a first embodiment of this invention, comprises a core 31, a plurality of back-iron portions 32, a plurality of windings 331, and a plurality of insulators 332. Each of the windings 331 and each of the insulators 332 constitute a winding portion 33.

The core 31 is used as a body of the stator 30 and provided with a hollow portion 311 and a plurality of tooth portions 312. The tooth portions 312 protrude from the hollow portion 311 in a radial manner.

The back-iron portions 32 are not integrally formed like the conventional back-iron portion as shown in FIG. 2, and they are separated into several parts. As a result, when the back-iron portions 32 are assembled to the core 31 to surround the core 31 and contact the insulators 332, they are assembled along a direction as shown by arrow X of FIG. 6 (that is, opposite to the protruding direction of the tooth portions 312).

Each of the insulators 332 corresponds to the tooth portions 312 and is disposed around the corresponding tooth portion 312 respectively. Each of the windings 331 corresponds to the insulators 332 and is disposed around the corresponding insulator 332 respectively. It is noted that the manner of assembling the winding portions 33 to the core 31 is the same as the conventional manner; therefore, its description is omitted.

In this embodiment, the back-iron portions 32 are connected with each other by welding 34.

It is understood that the core 31 and the back-iron portions 32 are preferably magnetic material.

As stated above, since the back-iron portions 32 are separated into several parts, they surround the core 31 along a direction opposite to the protruding direction of the tooth portions 312 during assembly. Thus, the insulators 332 of the winding portions 33 can be prevented from damage by the back-iron portions 32 when the back-iron portions 32 are assembled to the core 31. As a result, the reliability of the stator is enhanced.

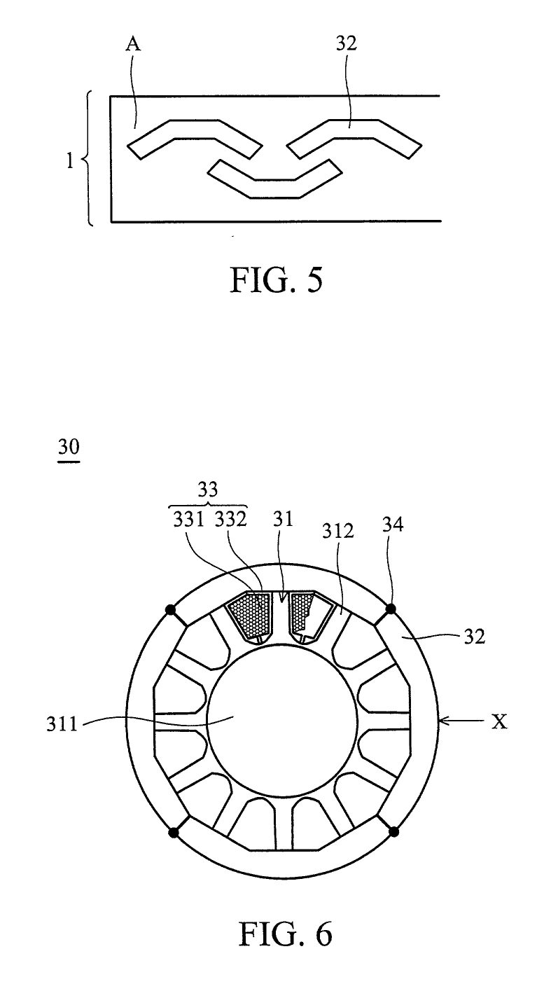

In addition, referring to FIG. 5, when the back-iron portions 32 of this embodiment are manufactured, a magnetic material A with smaller size 1 is required, compared with the conventional magnetic material as shown in FIG. 4. Thus, scraps remaining after manufacture can be largely reduced. As a result, the cost of the material is reduced, as is the cost of equipment.

It is understood that connection between the back-iron portions 32 is not limited to welding, for example, the back-iron portions can be connected with each other by adhesion.

Second Embodiment

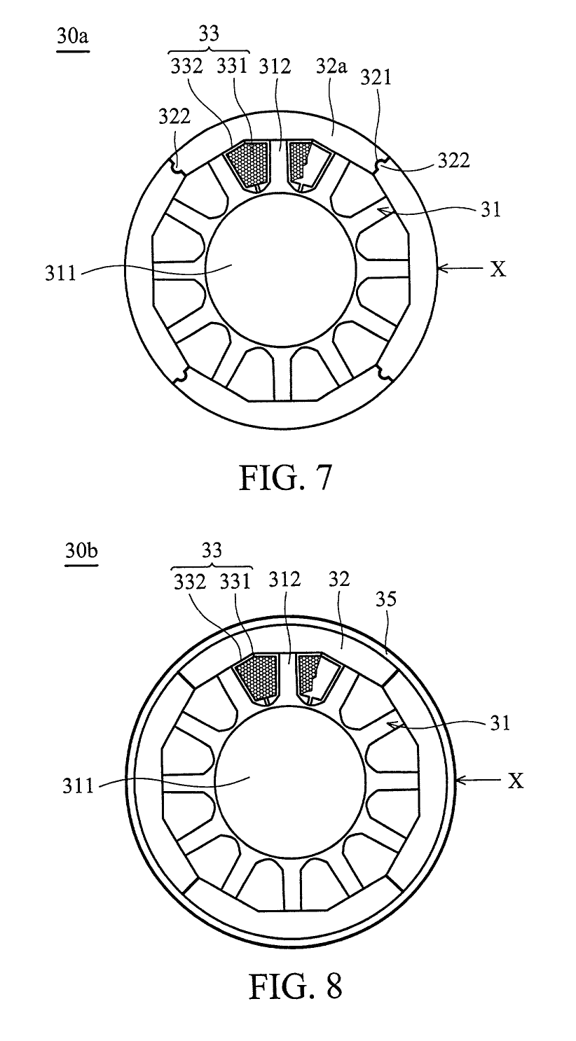

Referring to FIG. 7, a stator 30a for a motor, as disclosed in a second embodiment of this invention, comprises a core 31, a plurality of back-iron portions 32a, a plurality of windings 331, and a plurality of insulators 332. Each of the windings 331 and each of the insulators 332 constitute a winding portion 33.

The core 31 is used as a body of the stator 30a and provided with a hollow portion 311 and a plurality of tooth portions 312. The tooth portions 312 protrude from the hollow portion 311 in a radial manner.

The back-iron portions 32a are not integrally formed like the conventional back-iron portion shown in FIG. 2, and they are separated into several parts. As a result, when the back-iron portions 32a are assembled to the core 31 to surround the core 31 and contact the insulators 332, they are assembled along a direction as shown in arrow X of FIG. 7 (that is, opposite to the protruding direction of the tooth portions 312).

Furthermore, each of the back-iron portions 32a is provided with a recessed portion 321 and a projecting portion 322. Thus, the back-iron portions 32a are connected with each other by the engagement between the recessed portion 321 and the projecting portion 322.

Each of the insulators 332 corresponds to the tooth portions 312 and is disposed around the corresponding tooth portion 312 respectively. Each of the windings 331 corresponds to the insulators 332 and is disposed around the corresponding insulator 332 respectively. It is noted that the manner of assembling the winding portions 33 to the core 31 is the same as the conventional manner; therefore, its description is omitted.

Like the first embodiment, the insulators 332 of the winding portions 33 can be prevented from damage by the back-iron portions 32a since the back-iron portions 32a are assembled to the core 31 along a direction opposite to the protruding direction of the tooth portions 312. As a result, the reliability of the stator is enhanced. Also, the amount of scrap produced during manufacture can be largely reduced. As a result, the cost of the material is reduced, as is the cost of the equipment.

Third Embodiment

Referring to FIG. 8, a stator 30b for a motor, as disclosed in a third embodiment of this invention, comprises a core 31, a plurality of back-iron portions 32, a plurality of windings 331, a plurality of insulators 332, and a restricting portion 35. Each of the windings 331 and each of the insulators 332 constitute a winding portion 33.

The core 31 is used as a body of the stator 30b and provided with a hollow portion 311 and a plurality of tooth portions 312. The tooth portions 312 protrude from the hollow portion 311 in a radial manner.

The back-iron portions 32 are not integrally formed like the conventional back-iron portion as shown in FIG. 2, and they are separated into several parts. As a result, when the back-iron portions 32 are assembled to the core 31 to surround the core 31 and contact the insulators 332, they are assembled along a direction shown by arrow X of FIG. 8 (that is, opposite to the protruding direction of the tooth portions 312).

Each of the insulators 332 corresponds to the tooth portions 312 and is disposed around the corresponding tooth portion 312 respectively. Each of the windings 331 corresponds to the insulators 332 and is disposed around the corresponding insulator 332 respectively. It is noted that the manner of assembling the winding portions 33 to the core 31 is the same as the conventional manner; therefore, its description is omitted.

The restricting portion 35 surrounds the back-iron portions 32 so as to restrict the movement of the back-iron portions 32. Thus, the back-iron portions 32 can contact each other around the core 31.

Like the first embodiment, the insulators 332 of the winding portions 33 can be prevented from damage by the back-iron portions 32 since the back-iron portions 32 are assembled to the core 31 along a direction opposite to the protruding direction of the tooth portions 312. As a result, the reliability of the stator is enhanced. Also, the amount of scrap produced during manufacture can be largely reduced. As a result, the cost of the material is reduced, as is the cost of the equipment.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A stator for a motor comprising:
a core having a hollow portion and a plurality of tooth portions protruding from the hollow portion in a radial manner;
a plurality of insulators, corresponding to the tooth portions, disposed around the corresponding tooth portion respectively;
a plurality of windings, corresponding to the insulators, disposed around the corresponding insulator respectively; and
a plurality of back-iron portions surrounding the core and contacting the insulators along a direction opposite to the protruding direction of the tooth portions.

2. The stator as claimed in claim 1, wherein the back-iron portions are connected with each other by welding.

3. The stator as claimed in claim 1, wherein the back-iron portions are connected with each other by adhesion.

4. The stator as claimed in claim 1, wherein each of the back-iron portions is provided with a recessed portion and a projecting portion, whereby the back-iron portions are connected with each other by the engagement between the recessed portion and the projecting portion.

5. The stator as claimed in claim 1, further comprising:
a restricting portion surrounding the back-iron portions so that the back-iron portions contact each other around the core.

6. The stator as claimed in claim 1, wherein the core is magnetic material.

7. The stator as claimed in claim 1, wherein the back-iron portions are magnetic material.

8. A stator for a motor comprising:
a core having a hollow portion and a plurality of tooth portions protruding from the hollow portion in a radial manner; and
a plurality of back-iron portions surrounding the core and contacting the tooth portions along a direction opposite to the protruding direction of the tooth portions.

9. The stator as claimed in claim 8, wherein the back-iron portions are connected with each other by welding.

10. The stator as claimed in claim 8, wherein the back-iron portions are connected with each other by adhesion.

11. The stator as claimed in claim 8, wherein each of the back-iron portions is provided with a recessed portion and a projecting portion, whereby the back-iron portions are connected with each other by the engagement between the recessed portion and the projecting portion.

12. The stator as claimed in claim 8, further comprising:
a restricting portion surrounding the back-iron portions so that the back-iron portions contact each other around the core.

13. The stator as claimed in claim 8, wherein the core is magnetic material.

14. The stator as claimed in claim 8, wherein the back-iron portions are magnetic material.
